(19) United States
(12) Patent Application Publication
(10) Pub. No.: US 2026/0112216 A1
(43) Pub. Date: Apr. 23, 2026

(54) VEHICLE DIAGNOSIS MACHINE LEARNING SYSTEM

(71) Applicant: eBay Inc., San Jose, CA (US)

(72) Inventors: Luiz Carlos Miranda de Almeida Filho, Milpitas, CA (US); Johnny Dao, San Jose, CA (US); Sripriya Natarajan, San Jose, CA (US); Brandon Everett Smith, Cupertino, CA (US)

(73) Assignee: eBay Inc., San Jose, CA (US)

(21) Appl. No.: 18/918,446

(22) Filed: Oct. 17, 2024

(51) Int. Cl. G07C 5/08; G06F 3/0482

(52) U.S. Cl. CPC G07C 5/0808; G06F 3/0482

(57) ABSTRACT

A vehicle diagnosis machine-learning system is described. In one or more examples, the diagnostic service receives a query specifying a vehicle issue, identifying the vehicle corresponding to the query, and obtains the vehicle's history. The diagnostic service then generates a user question using one or more machine-learning models based on the query, the vehicle, and its history, and receives a response to this question via a user interface. A prompt is generated for processing by the machine-learning models, incorporating the query, vehicle, vehicle history, user question, and response. The result of processing of the prompt by a machine-learning model is presented to display in a user interface.

### BACKGROUND

Vehicle owners frequently grapple with stress and uncertainty stemming from limited access to professional diagnostic services, which can result in significant delays in addressing potentially serious issues. This lack of access is compounded by technical challenges that non-technical vehicle owners often face in accurately describing vehicle symptoms, thereby impeding effective communication with service professionals.

Moreover, the high cost of diagnostic services presents another technical challenge, as vehicle owners may be apprehensive about being overcharged for unnecessary repairs or misdiagnosed issues due to their lack of knowledge and insight into the causes of these repairs. The inconvenience of visiting a mechanic for a diagnosis further disrupts daily schedules, adding to the overall burden and hassle experienced by vehicle owners. Additionally, vehicle owners may harbor skepticism regarding the impartiality of diagnostics provided by entities that also offer repair services, fearing a conflict of interest.

### SUMMARY

A diagnostic system is described that addresses the technical challenges faced by vehicle owners, providing an accessible, precise, and accurate diagnostic tool that leverages artificial intelligence, machine learning, and integrated data sources to offer personalized diagnostic insights. The system implements an integrated diagnostic service that combines data from multiple sources, including vehicle repair trends, common faults, and maintenance records, to inform the diagnostic process and enable predictive analysis using machine learning to identify probable issues based on similar vehicle profiles and historical data.

The diagnostic system is configurable to access detailed records of the user's vehicle, including past services, repairs, and reported issues, allowing the diagnostic system to consider the vehicle's unique history when formulating diagnostic questions and solutions. By incorporating this detailed vehicle history, the diagnostic system provides diagnostic insights with increased relevance and accuracy.

The diagnostic system is also configurable to employ a user interface to output questions based on the symptoms provided by the vehicle owner. These questions are dynamically generated through leveraging the integrated data to focus on probable issues. The diagnostic system, for instance, is configurable to navigate through a decision tree, using the combined data sources to refine a line of inquiry and eliminate unprobable scenarios using a machine-learning model, e.g., a large language model. Upon reaching a diagnostic conclusion, the system offers customized repair or replacement options, considering the vehicle's service history, past part replacements, and broader trends.

By integrating these elements, the diagnostic system delivers personalized and insightful guidance, enhancing the vehicle ownership experience by offering a convenient alternative to conventional diagnostic techniques and limitations in user expertise. These technical advantages promote informed decisions about maintenance and repairs, addressing the technical challenges of stress, uncertainty, high costs, and skepticism faced by vehicle owners.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ vehicle diagnostic machine learning techniques described herein.

FIG. 2 depicts a system in an example implementation showing operation of a diagnostic service of FIG. 1 in greater detail.

FIG. 3 depicts a system in an example implementation showing operation of a diagnostic service of FIG. 1 in greater detail.

FIG. 4 illustrates an example of a user interface configured to receive a diagnostic query from a vehicle owner.

FIG. 5 illustrates an example of a user interface as part of an iterative process by a diagnostic service configured to refine a context of a vehicle issue as part of an interactive approach.

FIG. 6 illustrates an example of a user interface as part of an iterative process by the diagnostic service configured display a diagnostic result.

FIG. 7 is a flow diagram depicting an algorithm as a step-by-step procedure in an example implementation of operations performable for accomplishing a result of vehicle diagnosis using machine learning.

FIG. 8 is a flow diagram depicting another algorithm as a step-by-step procedure in an example implementation of operations performable for accomplishing a result of vehicle diagnosis using machine learning.

FIG. 9 illustrates an example system including various components of an example device that can be implemented as any type of computing device as described and/or utilize with reference to the previous figures to implement embodiments of the techniques described herein.

### DETAILED DESCRIPTION

### Overview

Vehicle owners often experience stress and uncertainty due to a lack of access to professional diagnostic services, which may lead to delays in addressing potentially serious issues. Additionally, non-technical vehicle owners may struggle to accurately describe vehicle symptoms, hindering effective communication with service professionals.

Further, diagnostic services may be expensive, and vehicle owners may be wary of being overcharged for unnecessary repairs or misdiagnosed issues due to a lack of knowledge and insight into causes for the repairs. Inconvenience involved in visiting a mechanic for a diagnosis may also disrupt daily schedules, adding to the overall burden and hassle faced by vehicle owners. Vehicle owners may also be skeptical of the impartiality of diagnostics provided by entities that also offer repair services, fearing a conflict of interest. These technical and logistical challenges make it difficult for vehicle owners to efficiently and accurately diagnose issues, leading to potential delays in repairs, increased costs, and overall inconvenience.

Accordingly, a diagnostic system is described that addresses these and other technical challenges by providing an accessible, precise, and accurate diagnostic tool that leverages artificial intelligence, machine learning, and integrated data sources to offer personalized diagnostic insights. A diagnostic system, in one or more examples, implements an integrated diagnostic service that combines data from multiple sources to provide a comprehensive and personalized vehicle diagnostic experience. The diagnostic system, for instance, is configurable to utilize a database of vehicle repair trends, common faults, and maintenance records to inform the diagnostic process, enabling predictive analysis to identify probable issues based on similar vehicle profiles and historical data.

The diagnostic system is also configurable to access detailed records of the user's vehicle, including past services, repairs, and any reported issues. The historical context allows the system to consider the vehicle's unique history when formulating diagnostic questions and solutions. By incorporating this detailed vehicle history, the diagnostic system is able to provide diagnostic insights with increased relevance and accuracy.

Additionally, the diagnostic system is configurable to address a user's history of previous parts purchases and maintenance activities to understand repair habits, preferences, and level of expertise. This information helps tailor recommendations to align with the user's typical behavior and budget considerations as well as to provide the information in a manner that is aligned with the user's ability to consume the information. The ability to analyze past purchase history assists the diagnostic system to promote configuration of suggestions that are both practical and cost-effective for the user. Other examples are also contemplated, including general trends for a particular vehicle manufacturer, model of vehicle, and so forth.

The diagnostic system is also configurable to employ a user interface to output questions based on the symptoms provided by the vehicle owner. These questions are dynamically generated by the diagnostic system through leveraging the integrated data to focus on probable issues. The diagnostic system is configurable to do so by navigating through a decision tree, using the combined data sources to refine a line of inquiry and deemphasize and even eliminate unprobable scenarios. Upon reaching a diagnostic conclusion, the system offers customized repair or replacement options, considering the vehicle's service history, past part replacements, and the broader trends.

By integrating these elements, the diagnostic system implements a service that delivers personalized and insightful guidance. The diagnostic system enhances a vehicle ownership experience by offering a convenient alternative to conventional diagnostic techniques and limitations in user expertise, thereby promoting informed decisions about maintenance and repairs. Further discussion of these and other examples are included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

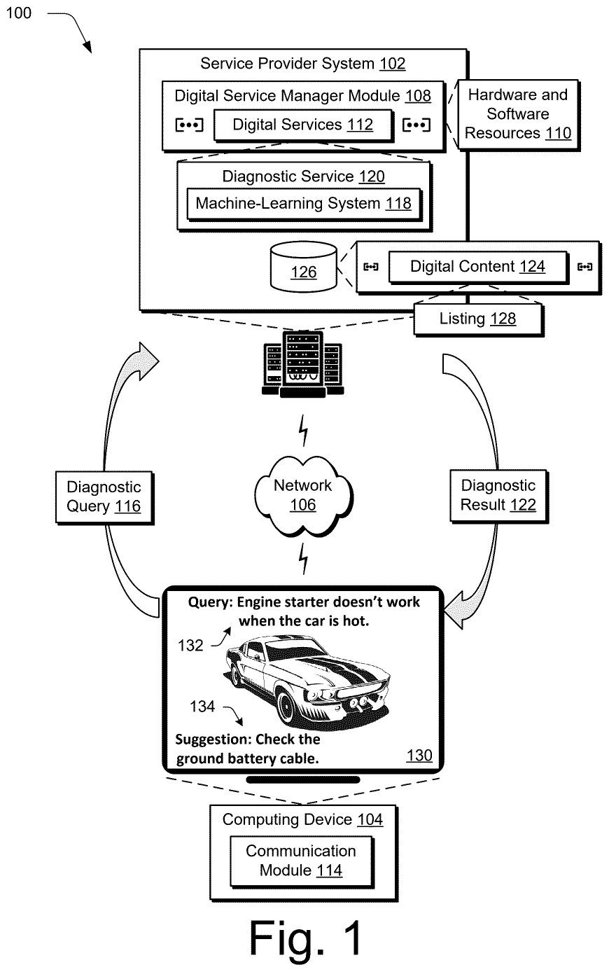

FIG. 1 is an illustration of a digital medium environment 100 in an example implementation that is operable to employ vehicle diagnostic machine learning techniques described herein. The illustrated environment 100 includes a service provider system 102 and a computing device 104 that are communicatively coupled, one to another, via a network 106. Computing devices are configurable in a variety of ways.

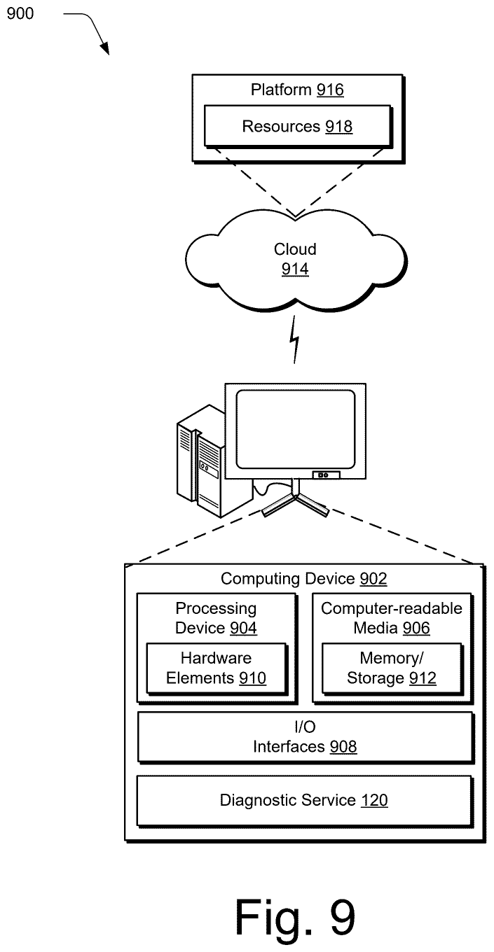

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 9.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, commerce website having listings 128 of goods or services (e.g., parts and other accessories for a vehicle) as digital content 124 stored in a storage device 126, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to receive a diagnostic query 116 from the computing device 104 and utilize a machine-learning system 118 to implement a diagnostic service 120 to generate a diagnostic result 122 as a response to the diagnostic query 116. The diagnostic query 116, for instance, is usable to state a vehicle issue with a vehicle using text, digital images, and so forth. Vehicles may take a variety of forms, including motorized forms such as automobiles, airplanes, boats, watercraft, motorcycles, scooters, drones, and so on. Nonmotorized vehicles are also contemplated, examples of which include bicycles, canoes, kayaks, kick scooters, skates, and so forth.

As previously described, vehicle owners often experience stress and uncertainty due to a lack of access to professional diagnostic services, which may lead to delays in addressing potentially serious issues. This lack of access can stem from several technical challenges. Typical vehicle owners, for instance, do not have access to advanced diagnostic tools that are generally available solely to professional mechanics, which are useful for accurately identifying and diagnosing complex vehicle issues. Conventional diagnostic techniques also often involve physical inspection and manual testing, which can be time-consuming and delay the identification and resolution of issues. Yet further, conventional diagnostic systems may lack the capability to seamlessly integrate and analyze various data sources resulting in incomplete or inaccurate diagnoses. Remote diagnostics, which allow for the assessment of vehicle issues without involving a physical visit to a mechanic, are not widely available, forcing vehicle owners to rely on conventional, in-person diagnostic services that can be inconvenient and time-consuming.

Further, conventional diagnostic tools and systems are generally designed with professional mechanics in mind and may not be user-friendly for non-technical vehicle owners, making it difficult for effective use of these tools to diagnose and understand vehicle issues. Professional diagnostic services can also be expensive, deterring vehicle owners from seeking timely diagnostics and leading to delays in addressing issues until they become more severe. The reliance on physical inspections and manual testing further limits the ability to quickly and efficiently diagnose issues, especially for vehicle owners who may not have easy access to professional mechanics. These technical challenges contribute to the overall stress and uncertainty experienced by vehicle owners, making it difficult for them to efficiently and accurately diagnose issues, leading to potential delays in repairs, increased costs, and overall inconvenience.

Additionally, non-technical vehicle owners may struggle to accurately describe vehicle symptoms, hindering effective communication with service professionals even when available. This communication gap can lead to several issues. For instance, vehicle owners might use vague or incorrect terminology to describe the problem, which can result in misdiagnosis or an incomplete understanding of the issue by the mechanic. Miscommunication can cause delays in identifying the root cause of the problem, leading to prolonged repair times and increased costs.

Thus, the inability to effectively communicate symptoms can result in unnecessary repairs or replacement of parts, as mechanics may then rely on trial-and-error methods to pinpoint the issue. These complications add to the expense and also increase the inconvenience for the vehicle owner, which may involve multiple visits to the repair shop. In some cases, central issues might be overlooked or misinterpreted, potentially compromising the safety and reliability of the vehicle. Therefore, the lack of technical knowledge and the resulting communication barriers significantly impact the efficiency and accuracy of vehicle diagnostics and repairs.

Accordingly, the diagnostic service 120 is configurable to address these and other technical challenges through support of an efficient user interface to assist users in identification a probable causes and/or solutions to vehicle issues. The diagnostic service does so by bridging a knowledge gap and reducing time and expense associated with conventional diagnostic techniques. As a result, users are empowered through use of the diagnostic service 120 to make informed decisions regarding vehicle maintenance and repair.

The diagnostic service 120 is configured to support an intuitive user interface that guides users through the process of identifying vehicle symptoms and issues. In the illustrated example user interface 130, the diagnosis system receives a first example 132 of a diagnostic query 116 of “engine starter doesn't work when the car is hot.” Processing of the diagnostic query 116 by a machine-learning system 118 of the diagnostic service 120 is the used to produce a second example 134 of a diagnostic result 122 of “check the ground battery cable” as a probable fix to the vehicle issue. The diagnostic service 120, for instance, may implement one or more machine-learning models as classifiers that output respective probabilities, use a large language model, and so on. In this way, the diagnostic service 120 implements a robust decision-making algorithm that suggests potential diagnoses based on user input.

The diagnostic service 120 is also configured to implement a “chatbot” generate questions based on the answers provided. The diagnostic service 120 is also configurable to leverage a variety of data sources in generating the diagnostic result 122, including a past vehicle history, vehicle history of the make and model as a whole, service bulletins, service, trends, and so forth and base its logic on the Service Trend Advisor data purchased from vendors.

The diagnostic result 122 is then configurable as actionable advice and recommendations for next steps, including do-it-yourself (DIY) solutions and referrals to trusted professionals. The diagnostic service 120 enhances the car ownership experience by offering a convenient and trustworthy alternative to conventional diagnostic techniques. By addressing these problems, the diagnostic service 120 helps clarify car diagnostics for the average owner, leading to better maintenance practices, safer driving conditions, and overall cost savings. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Vehicle Diagnosis Machine Learning System

The following discussion describes vehicle diagnosis techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

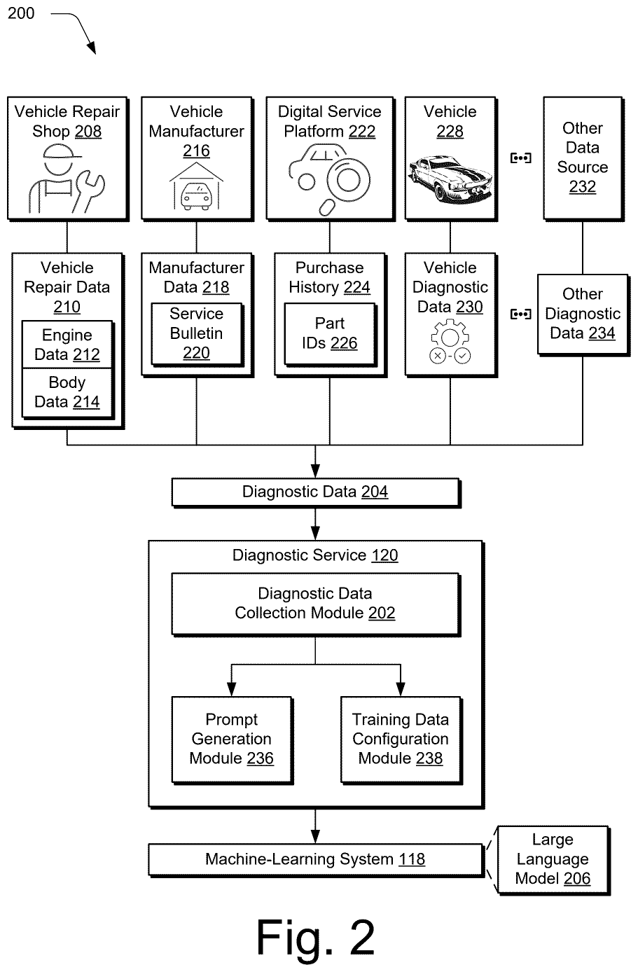

FIG. 2 depicts a system 200 in an example implementation showing operation of the diagnostic service 120 of FIG. 1 in greater detail. The diagnostic service 120 includes a diagnostic data collection module 202 to collect diagnostic data 204 from a variety of data sources. The diagnostic data 204 is configured to aid in generation of the diagnostic result 122. The diagnostic data 204, for instance, is usable as a supplement by the machine-learning system 118 (e.g., implementing a large language model 206) to provide context to the diagnostic query 116. The diagnostic data 204 is configurable in a variety of ways.

In a first example, the diagnostic data 204 is obtained from a vehicle repair shop 208 as vehicle repair data 210. This includes engine data 212 describing engine operation, part replacement, maintenance performed, and so forth. Additional examples of vehicle repair data 210 that can be obtained from the vehicle repair shop 208 include transmission data detailing transmission performance, fluid levels, and any transmission-related repairs or replacements. Brake system data can also be collected, encompassing information on brake pad wear, brake fluid levels, and any repairs or replacements made to the braking system.

Suspension system data is another example, which includes details on shock absorber performance, alignment adjustments, and replacements or repairs made to the suspension components. Electrical system data can be gathered, providing insights into battery health, alternator performance, battery charging for EV applications, as well as and any electrical repairs or replacements. Furthermore, body data 214 is contemplated, describing repairs or alterations made to the body of the vehicle, such as paint jobs, dent repairs, and structural modifications.

This information may be obtained through digital records maintained by the vehicle repair shop 208, which can be accessed via a secure data transfer protocol. Alternatively, the vehicle repair shop 208 may provide physical records that are digitized and integrated into the diagnostic system. The vehicle repair shop 208 may also utilize telematics data collected from the vehicle during service visits, which can be transmitted directly to the diagnostic service 120 for analysis.

In a second example, the diagnostic data 204 is obtained from a vehicle manufacturer 216 as manufacturer data 218 which may describe how the vehicle is assembled, parts involved, service bulletins 220 identified by the vehicle manufacturer 216 for vehicle issues, and so forth. Additional examples of manufacturer data 218 that can be obtained from the vehicle manufacturer 216 include technical specifications detailing design and engineering aspects of the vehicle, such as engine configurations, transmission types, and electrical system layouts. Recall notices can also be included, providing information on any recalls issued for specific parts or systems within the vehicle.

Furthermore, manufacturer data 218 may encompass software updates and firmware patches that have been released to address known issues or improve vehicle performance. Diagnostic trouble codes (DTCs) and their corresponding descriptions can also be provided, offering insights into specific error codes that the vehicle's onboard diagnostic system may generate. Additionally, the vehicle manufacturer 216 may supply maintenance schedules and recommended service intervals, which can help in identifying whether a vehicle issue is related to overdue maintenance tasks.

The manufacturer data 218 may be obtained through direct access to the vehicle manufacturer's 216 digital databases via secure data transfer protocols. Alternatively, the vehicle manufacturer 216 may provide physical documentation that is digitized and integrated into the diagnostic system. The vehicle manufacturer 216 may also utilize telematics data collected from the vehicle during its lifecycle, which can be transmitted directly to the diagnostic system for analysis over the network 106.

A digital service platform 222 is also illustrated as a data source of a purchase history 224 and corresponding parts IDs 226 for parts purchased for the vehicle 228. The purchase history 224, for instance, is configurable as a part purchase history detailing which parts have been purchased by a respective user in the past. The digital service platform 222, for instance, provides digital services, including listings 128 of parts that are purchased by an owner of the vehicle. These listings 128 are accessible through a user interface, allowing vehicle owners to search for and purchase parts specific to their vehicle's make and model. The digital service platform 222 is configurable to include a comprehensive database includes a wide range of parts, from common replacements like brake pads and filters to specialized components such as engine parts and electronic modules.

The purchase history 224 maintained by the digital service platform 222 offers valuable insights into how a particular vehicle is maintained. By analyzing the parts purchased over time, the diagnostic service 120 can infer the maintenance habits of the vehicle owner, such as the frequency of oil changes, brake replacements, and other routine services. This information helps the diagnostic system tailor its recommendations to align with the owner's typical maintenance practices and budget considerations.

Moreover, the purchase history 224 can provide insights into vehicle issues of other vehicles of the same make and model. By aggregating data from multiple vehicles, the diagnostic service 120 can identify common problems and the parts frequently purchased to address those issues. For example, if a significant number of owners of a particular vehicle model are purchasing a specific type of sensor, it may indicate a common failure point for that model. This aggregated data allows the diagnostic service 120 to predict potential issues for a given vehicle based on the experiences of other owners with similar vehicles.

Additionally, the purchase history 224 can offer insights into the success of fixes to vehicle issues based on which parts are purchased via the digital service platform 222. By tracking the parts purchased and correlating them with subsequent diagnostic queries and feedback, the system can evaluate the effectiveness of different repair strategies. For instance, if a particular replacement part consistently resolves a specific issue across multiple vehicles, the diagnostic system can recommend that part with higher confidence. Conversely, if certain parts are frequently purchased but do not lead to successful repairs, the diagnostic service 120 is configurable to adjust its recommendations accordingly. In an implementation, this confidence value is surfaced as part of the diagnostic result 122 to indicate a likelihood of success.

As a result, the digital service platform 222 facilitates the purchase of vehicle parts and also serves as a rich data source for the diagnostic system. The purchase history 224 provides a detailed record of maintenance activities, common issues, and the effectiveness of various repairs, enabling the system to deliver more accurate and personalized diagnostic insights.

In another example, the vehicle 228 itself is configured to provide the vehicle diagnostic data 230 directly, e.g., via a user's application associated with the vehicle, via a connection for an internal modem of the vehicle 228 itself, and so forth. The vehicle diagnostic data 230, for instance, is configurable to give insight into battery health, how the vehicle 228 is operated, installation of software updates, and so forth. Other data sources 232 are also contemplated to provide other diagnostic data 234, including use of message boards, existence of instructional repair videos corresponding to the vehicle 228, and so forth.

The diagnostic data 204, once collected, is usable by the diagnostic service 120 in a variety of ways. In a first example, a prompt generation module 236 employs the diagnostic data 204 along with the diagnostic query 116 as part of a prompt that is communicated to the machine-learning system 118 for processing, e.g., by a large language model 206. Thus, in this example the diagnostic data 204 is not used to train the machine-learning system 118 but rather is employed to give context to the diagnostic query 116. In another example, the diagnostic data 204 is used as training data by a training data configuration module 238 to train a machine-learning model, which may also be performed for the large language model 206 or other types of machine-learning models.

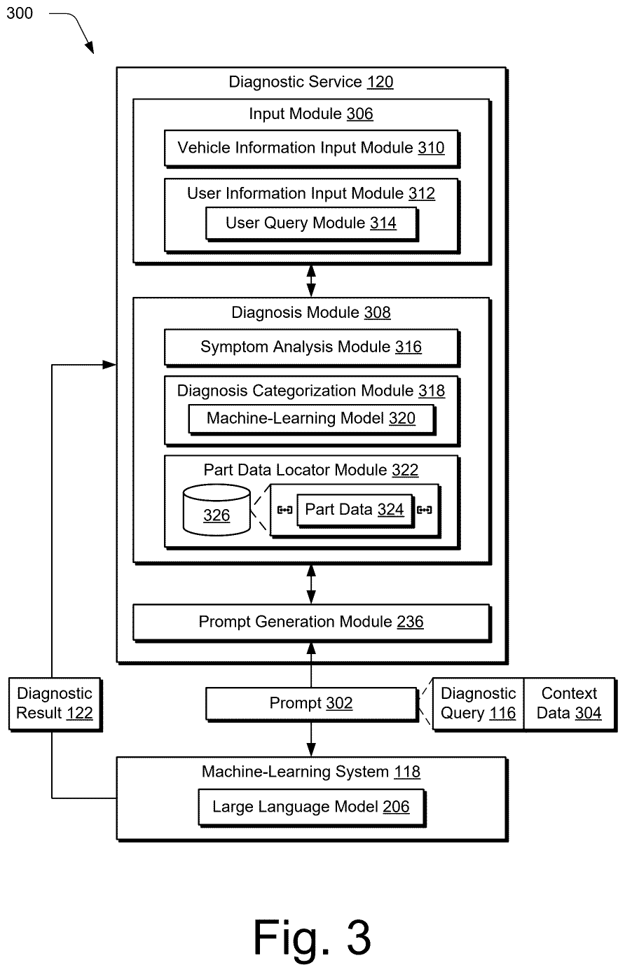

FIG. 3 depicts a system 300 in an example implementation showing operation of the diagnostic service 120 of FIG. 1 in greater detail. The diagnostic service 120 in this example employs the prompt generation module 236 to generate a prompt 302 for processing by the large language model 206. The prompt 302 includes the diagnostic query 116 as well as context data 304 collected by the diagnostic data collection module 202 as previously described in relation to FIG. 2.

Accordingly, the diagnostic service 120 includes an input module 306, a diagnosis module 308, and the prompt generation module 236. The input module 306 includes a vehicle information input module 310 to collect information about the vehicle 228, e.g., the vehicle repair data 210, manufacturer data 218, purchase history 224, vehicle diagnostic data 230, and so on.

A user information input module 312 is also included that represents functionality to query a user via the user interface 130, e.g., as to a general diagnostic query 116 as well as generate questions to further provide context to the search through use of a user query module 314. The input module 306, for instance, is configurable to being by first posing one or more questions to the user to input basic information about a vehicle, e.g., make, model, year, VIN number, and so forth. This information may be saved, e.g., as part of a “garage” by the diagnostic service 120.

The diagnosis module 308, as illustrated, includes a symptom analysis module 316, a diagnosis categorization module 318 that employes a machine-learning model 320, and a part data locator module 322 that is configured to locate part data 324, which is illustrated as stored in a storage device 326. The symptom analysis module 316, for instance, is configured to analyze the diagnostic query 116 using natural language processing (NLP) to identify symptoms and issues. Based on the initial analysis, a diagnosis categorization module 318 categorizes the diagnostic query 116 into broader areas, such as engine, transmission, brakes, electrical, software, and so forth. The initial analysis, for instance, includes use of the part data locator module 322 to obtain part data 324 from parts related to the diagnostic query 116. To do so, the part data locator module 322 employs a retrieval-augmented generation (RAG) model, which is a type of machine learning model that combines retrieval based and generation based approaches. The part data 324, for instance, is maintained as part of a vector database as part of an embedding space generates for parts and related symptoms using machine learning.

After initial symptom analysis, the diagnosis module 308 further refines the initial set of parts list by filtering using service trend advisor data. Service trend advisor is implemented as functionality within a warehouse inventory (WHI) platform that provides a ranked list of frequently replaced parts for a particular vehicle. This ranking is based on historical data and trends observed across numerous vehicles of the same make and model. The service trend advisor data is updated monthly on the WHI platform to ensure that the information remains current and reflects the latest trends in vehicle maintenance and repair.

Thus, the WHI platform is a comprehensive digital solution used by automotive professionals to manage inventory, access parts catalogs, and streamline the procurement process. The WHI platform integrates various data sources, including manufacturer information, repair shop data, and market trends as described in relation to FIG. 2 to offer a robust and reliable resource for vehicle diagnostics and parts management. The platform's extensive database includes detailed information on parts, their compatibility with different vehicle models, and their historical performance in repairs.

In this way, the diagnosis module 308 leverages this extensive database to identify parts that are commonly replaced in specific vehicle models. By analyzing repair trends and historical data, the diagnosis module 308 can predict which parts are most probable to need replacement, helping mechanics and vehicle owners make informed decisions about maintenance and repairs. This predictive capability is particularly valuable for diagnosing issues and planning preventive maintenance, as it highlights potential problem areas before they lead to more significant issues.

The filtered parts list, now refined with trends and historical data, allows the diagnostic service 120 to focus on probable causes of the vehicle issue. This targeted approach improves the accuracy of the diagnosis and also enhances overall efficiency of the diagnostic process, saving time and computational resources as well as reducing a likelihood of unnecessary repairs.

The diagnostic service 120, through use of the user query module 314, is configured to generate a series of targeted questions to narrow down possible causes of the vehicle issue. These questions may be based on the category of the issue and the initial symptoms described by the user. For example, if the user mentions a noise coming from the engine, the user query module 314 is configurable to generate a series of questions over multiple iterations such as: (1) “When do you hear the noise (e.g., during startup, while accelerating, at idle)?” (2) “Do you also have squeaky Wheels (e.g., knocking, hissing, squealing)?” (3) “Have any warning lights come on for Tire pressure?” (4) “Have any warning lights come on?” and so on. Over a number of iterations, for instance, the diagnosis module 308 determines that a threshold probability has been reached that at least one possible fix to the vehicle issue is correct.

The diagnostic result 122 generated by the diagnostic service 120 can encompass a variety of outputs tailored to assist the vehicle owner in diagnosing and resolving the vehicle issue, including potential safety warnings. For instance, the diagnostic result 122 may include a list of potential causes for the vehicle issue, each accompanied by a probability score indicating the likelihood that the option is correct. This probability score is derived from the machine-learning model's analysis of the query, vehicle history, and user responses.

Additionally, the diagnostic result 122 can provide actionable advice and recommendations for next steps. For example, if the diagnostic result 122 identifies a potential issue with the vehicle's battery, it may suggest simple checks the user can perform, such as inspecting the battery terminals for corrosion or ensuring the battery cables are securely connected. The diagnostic result 122 can also include links to tutorial videos that guide the user through these checks, enhancing the user's ability to perform basic diagnostics and repairs independently.

Furthermore, the diagnostic result 122 can reference message platforms or forums where users can seek advice from other vehicle owners or professionals who have experienced similar issues. This community-based support can provide additional insights and potential solutions that may not be immediately apparent from the diagnostic system alone.

For each potential cause or solution included in the diagnostic result 122, the system can output a representation, such as a bar graph or pie chart, indicating the probability that the option is correct. This visual representation helps the user quickly understand the most probable causes and prioritize their diagnostic efforts accordingly. For instance, if the diagnostic result 122 suggests three potential issues—battery failure, alternator malfunction, and starter motor problem—the system can display a bar graph showing the probability of each issue, with battery failure at 70%, alternator malfunction at 20%, and starter motor problem at 10%.

The diagnostic result 122 can include recommendations with a ranked list of parts, which leads to search results from the digital service platform 222. Additionally, the diagnostic result 122 can provide referrals to professionals. The diagnostic result 122, for instance, is configurable to include offers to connect a user with local mechanics or dealerships that are qualified to resolve the issue. The diagnostic service 120 may also provide estimated repair costs and time frames based on the diagnosed issues.

After the user takes action based on the diagnostic result 122, the diagnostic service 120 is configurable to collect feedback on the outcome. The feedback may be generated through follow-up questions, surveys, or a like/dislike button in the user interface. The feedback is used to determine whether the suggested solution resolved the issue.

By integrating these elements, the diagnostic service 120 not only provides a comprehensive diagnostic result 122 but also empowers vehicle owners with the tools and resources usable to address vehicle issues. This approach enhances the overall vehicle ownership experience by reducing the time, cost, and uncertainty associated with traditional diagnostic techniques.

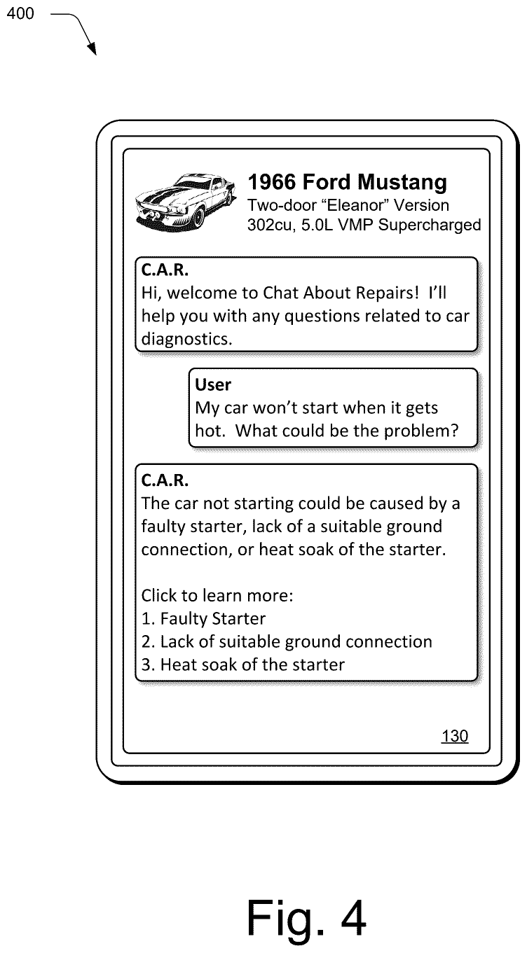

FIG. 4 illustrates an example 400 of a user interface 130 configured to receive a diagnostic query from a vehicle owner. In this example, the user inputs the query “My car won't start when the engine gets hot. What could be the problem?” into the diagnostic system. Upon receiving this query, the diagnostic service 120 processes the input and generates a follow-up question to gather additional context through use of the user query module 314. The follow-up question presented to the user in the illustrated example includes: “The car not starting could be caused by a faulty starter, lack of a suitable ground connection, or heat soak of the starter.”

In response, the diagnostic service 120 provides user-selectable options for the user to learn more about each potential cause. The options displayed are: “1. Faulty Starter,” “2. Lack of suitable ground connection,” and “3. Heat soak of the starter.” By selecting one of these options, the user can access detailed information about the specific issue, including possible diagnostic steps and recommended actions.

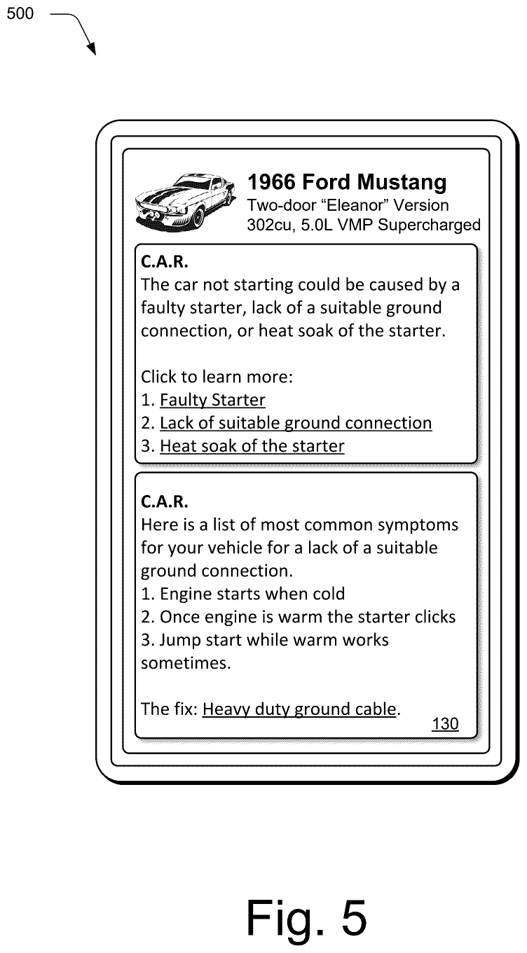

FIG. 5 illustrates an example 500 of a user interface as part of an iterative process by the diagnostic service 120 configured to refine a context of a vehicle issue as part of an interactive approach. Continuing from the discussion in FIG. 4, FIG. 5 illustrates the user interface 130 as it further refines the diagnostic process based on the user's input. After the user selects “Lack of suitable ground connection” from the options provided, the diagnostic service generates a detailed list of common symptoms associated with this issue.

The user interface 130 displays: “Here is a list of most common symptoms for your vehicle for a lack of a suitable ground connection. 1. Engine starts when cold 2. Once engine is warm the starter clicks 3. Jump start while warm works sometimes.” Additionally, the user interface includes a link that is user-selectable to initiate a purchase of a corresponding part from the digital service platform 222. In this example, the link is labeled “Heavy duty ground cable,” allowing the user to conveniently purchase the necessary part to address the identified issue directly from the platform.

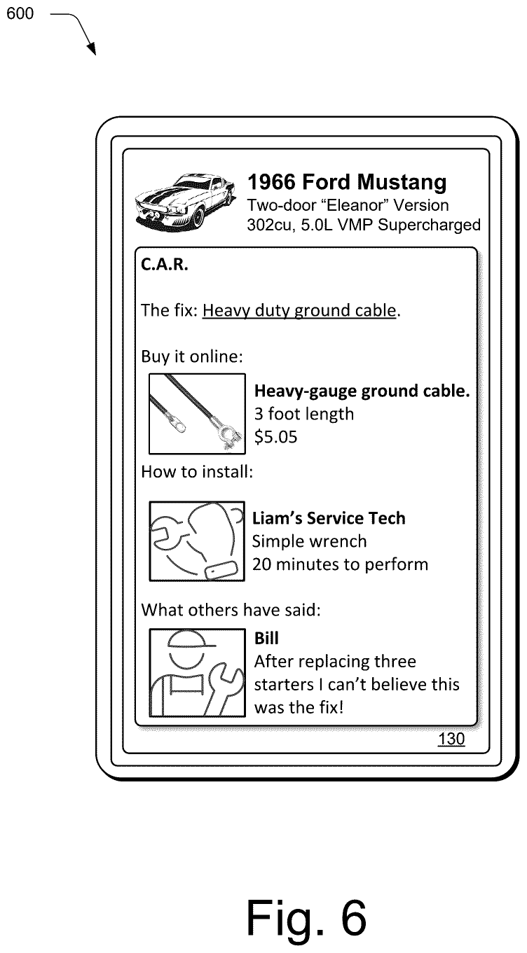

FIG. 6 illustrates an example 600 of a user interface 130 as part of an iterative process by the diagnostic service 120 configured display a diagnostic result 122. Continuing from the discussion in FIG. 5, FIG. 6 illustrates the user interface 130 displaying a diagnostic result 122 based on the user's input. The diagnostic result includes an option that is user-selectable to purchase a part involved in the vehicle issue, specifically a “Heavy duty ground cable,” from the digital service platform 222.

Additionally, the user interface provides a link to a digital video explaining how to perform the fix, tailored to the user's specified level of expertise. This ensures that the instructions are accessible and comprehensible to the user. The prompt generation module 236, for instance, is configurable to generate a prompt 302 that specifies a level of expertise to be used in generating the diagnostic result 122 such that the result is readily understood.

Furthermore, the user interface 130 includes a result from a message board rating the fix, offering insights and feedback from other users who have encountered and resolved similar issues. This comprehensive approach not only guides the user through diagnosing the problem but also provides practical solutions and community-driven support to enhance the overall vehicle repair experience.

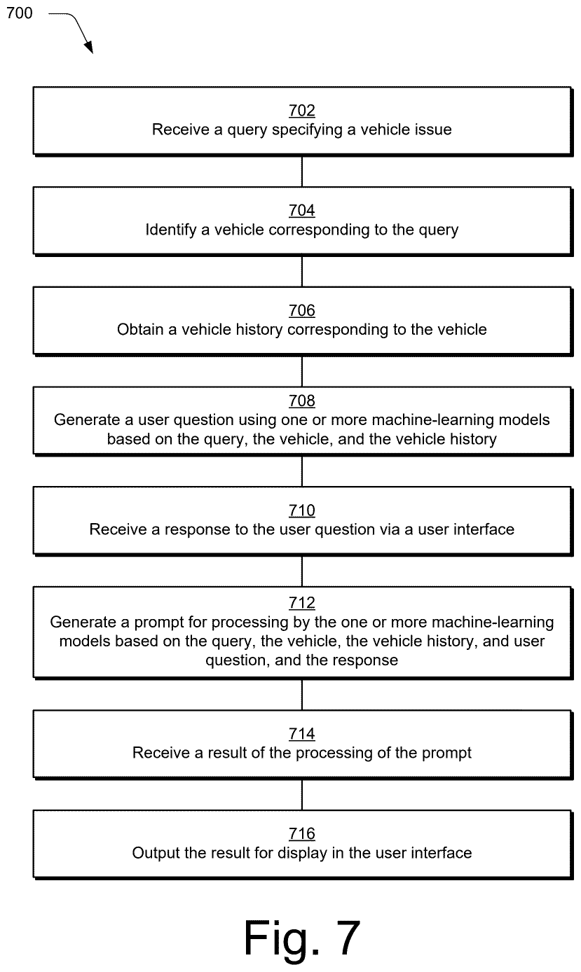

FIG. 7 is a flow diagram depicting an algorithm 700 as a step-by-step procedure in an example implementation of operations performable for accomplishing a result of vehicle diagnosis using machine learning. The algorithm 700 begins at block 702, where the system receives a query specifying a vehicle issue. This query is processed by the input module 306, which includes the vehicle information input module 310 and the user information input module 312.

Next, at block 704, the system identifies a vehicle corresponding to the query using the vehicle information input module 310. The vehicle may be identified through a variety of techniques, such as inputting the vehicle's make, model, year, and VIN number, or by accessing a saved profile in the user's “garage” within the diagnostic service. Additionally, the diagnostic service 120 can retrieve vehicle information from connected data sources like vehicle repair shops, manufacturers, or digital service platforms as previously described in relation to FIG. 2.

At block 706, the diagnostic service 120 obtains a vehicle history corresponding to the vehicle. This history is gathered from various data sources, such as vehicle repair data 210, manufacturer data 218, and purchase history 224, as managed by the diagnosis module 308. The vehicle history provides context for the diagnostic process.

At block 708, the system generates a user question using one or more machine-learning models based on the query, the vehicle, and the vehicle history. Generation of the question is facilitated by the user query module 314, which dynamically generates questions to refine the diagnostic process. The diagnostic service 120 then receives a response to the user question via a user interface at block 710.

At block 712, the system generates a prompt for processing by the one or more machine-learning models. The prompt is based on the query, the vehicle, the vehicle history, the user question, and the response. This prompt is created by the prompt generation module 236 and processed by the large language model (LLM) 304 within the machine-learning system 118.

At block 714, the system receives a result of the processing of the prompt. This result is then output for display in the user interface at block 716, providing the user with actionable diagnostic insights and recommendations. This comprehensive process ensures that the diagnostic service 120 delivers accurate and personalized guidance to the vehicle owner.

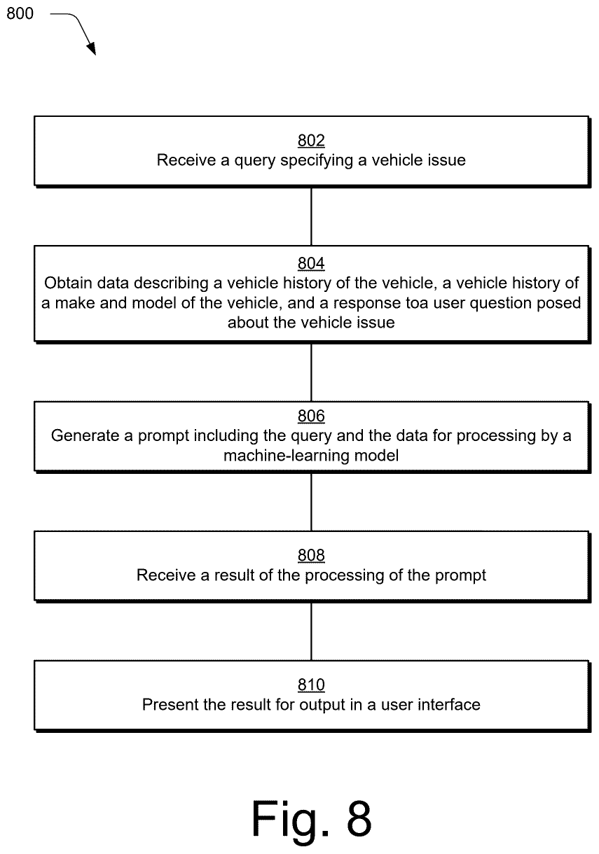

FIG. 8 is a flow diagram depicting another algorithm 800 as a step-by-step procedure in an example implementation of operations performable for accomplishing a result of vehicle diagnosis using machine learning. The algorithm 800 begins at block 802, where the diagnostic service 120 receives a query specifying a vehicle issue. This query is processed by the input module 306, which includes the vehicle information input module 310 and the user information input module 312.

Next, at block 804, the diagnostic service 120 obtains data describing a vehicle history of the vehicle, a vehicle history of a make and model of the vehicle, and a response to a user question posed about the vehicle issue. The data is gathered from various sources, such as vehicle repair data 210, manufacturer data 218, and purchase history 224, as managed by the diagnosis module 308.

At block 806, the diagnostic service 120 generates a prompt including the query and the data for processing by a machine-learning model. The prompt is created by the prompt generation module 236 and processed by the large language model (LLM) 304 within the machine-learning system 118. The system then receives a result of the processing of the prompt at block 808.

At block 810, the diagnostic service 120 presents the result for output in a user interface, providing the user with actionable diagnostic insights and recommendations. In this way, the diagnostic service 120 offers significant technical advantages by leveraging artificial intelligence, machine learning, and integrated data sources to provide precise and personalized vehicle diagnostic insights. This diagnostic service 120 overcomes several technical challenges faced by vehicle owners, such as the lack of access to professional diagnostic tools, the difficulty in accurately describing vehicle symptoms, and the high cost and inconvenience of traditional diagnostic services. B y integrating data from vehicle repair trends, manufacturer records, and past purchase histories, the diagnostic service 120 can generate contextually relevant questions and provide accurate diagnostic results. This approach bridges the knowledge gap for non-technical users and also reduces the time and expense associated with conventional diagnostic methods, ultimately enhancing the vehicle ownership experience by offering a convenient, trustworthy, and efficient alternative.

### Example System and Device

FIG. 9 illustrates an example system generally at 900 that includes an example computing device 902 that is representative of one or more computing systems and/or devices that implement the various techniques described herein. This is illustrated through inclusion of the diagnostic service 120. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a query specifying a vehicle issue;
identifying a vehicle corresponding to the query;
obtaining a vehicle history corresponding to the vehicle;
generating a user question using one or more machine-learning models based on the query, the vehicle, and the vehicle history;
receiving a response to the user question via a user interface;
generating a prompt for processing by the one or more machine-learning models, the prompt based on the query, the vehicle, the vehicle history, the user question, and the response;
receiving a result of the processing of the prompt by the one or more machine-learning models as an answer to the vehicle issue; and
outputting the result for display in the user interface.

2. The method as described in claim 1, wherein the vehicle history describes a service history for the vehicle.

3. The method as described in claim 2, wherein the vehicle history describes a part purchase history for the vehicle.

4. The method as described in claim 1, wherein the vehicle history is collected for a plurality of instances of a make and model of the vehicle.

5. The method as described in claim 4, wherein the vehicle history describes a part purchase history for the plurality of instances of a make and model of the vehicle via a digital service implemented via a digital platform.

6. The method as described in claim 1, wherein the result specifies a probable source of the vehicle issue.

7. The method as described in claim 1, wherein the result specifies a probable fix for the vehicle issue.

8. The method as described in claim 1, wherein the prompt specifies a level of expertise to be used and a level of detail for the result.

9. A method comprising:
receiving a query via a display of a user interface including an option to specify a vehicle issue;
displaying a plurality of options of a possible cause of the vehicle issue, the plurality of options generated using a large language model based on the query;
receiving a selection of an option from the plurality of options;
responsive to the selection, obtaining data describing parts identified as associated with the vehicle issue;
forming a prompt for processing by the large language model, the prompt including the query and the data; and
presenting a result of the processing of the prompt by the large language model for display in the user interface.

10. The method as described in claim 9, wherein the obtaining includes obtaining additional data describing a list of the parts identified as associated with the vehicle issue for a vehicle identified via the user interface as associated with the vehicle issue and the prompt includes the additional data.

11. The method as described in claim 9, wherein the obtaining includes obtaining additional data describing a purchase history of parts for a vehicle identified via the user interface as associated with the vehicle issue and the prompt includes the additional data.

12. The method as described in claim 9, wherein the obtaining includes obtaining additional data describing one or more service bulletins associated with a vehicle identified via the user interface as associated with the vehicle issue and the prompt includes the additional data.

13. The method as described in claim 9, wherein the obtaining includes obtaining additional data describing diagnostic data from a vehicle identified via the user interface as associated with the vehicle issue and the prompt includes the additional data.

14. The method as described in claim 9, wherein the obtaining includes obtaining additional data describing one or more repairs made to a vehicle identified via the user interface as associated with the vehicle issue and the prompt includes the additional data.

15. A computing device comprising:
a processing device; and
a computer-readable storage medium storing instructions that, responsive to execution by the processing device, causes the processing device to perform operations including:
receiving a query specifying a vehicle issue;
obtaining data describing a vehicle history of the vehicle, a vehicle history of a make and model of the vehicle, and a response to a user question posed about the vehicle issue;
generating a prompt including the query and the data for processing by a machine-learning model to identify a corrective action to the vehicle issue;
receiving a result of the processing of the prompt by the machine-learning model; and
presenting the result for output in a user interface.

16. The computing device as described in claim 15, wherein the result specifies a probable fix for the vehicle issue.

17. The computing device as described in claim 15, wherein the prompt specifies a level of expertise to be used a level of detail for the result.

18. The computing device as described in claim 15, wherein the vehicle history describes a part purchase history of parts specific to the vehicle.

19. The computing device as described in claim 15, wherein the vehicle history of a make and model of a vehicle is collected for a plurality of instances of the vehicle.

20. The computing device as described in claim 19, wherein the vehicle history describes a part purchase history for the plurality of instances of the make and model of the vehicle via a digital service implemented via a digital platform.
